(19) United States
(12) Patent Application Publication
(10) Pub. No.: US 2026/0081546 A1
(43) Pub. Date: Mar. 19, 2026

(54) LOAD BANK SYSTEM FOR A GENERATOR SET

(71) Applicant: Rolls-Royce Solutions GmbH, Friedrichshafen (DE)

(72) Inventors: Conrad Dieken, North Mankato, MN (US); Nicholas Kolhoff, Mankato, MN (US); James Maercklein, Mankato, MN (US); Dibiz Kansakar, Maple Grove, MN (US); Lenny Hill, Le Sueur, MN (US); Jessica Wanderscheid, Mankato, MN (US)

(73) Assignee: Rolls-Royce Solutions GmbH, Friedrichshafen (DE)

(21) Appl. No.: 18/890,098

(22) Filed: Sep. 19, 2024

(51) Int. Cl. H02P 9/02; F02B 63/04; H02P 9/06

(52) U.S. Cl. CPC H02P 9/02; F02B 63/044; H02P 9/06; F02B 2063/045

(57) ABSTRACT

A generator set system includes: a generator set including an engine and a generator operatively coupled with the engine; a radiator operatively coupled with the engine; and a load bank system including: a load bank mounted to the radiator and including a resistor array; and a load bank control panel operatively coupled with and spaced apart from the load bank.

### BACKGROUND OF THE INVENTION

### 1. Field of the Invention

The present invention relates to generator sets, and, more particularly, to load bank systems of generator sets.

### 2. Description of the Related Art

A generator set system (also known as a genset system) is known to include a generator set, which includes an engine and a generator. The engine produces mechanical energy, and the generator converts the mechanical energy produced by the engine into electrical energy, which is used to power one or more other electrically powered devices.

The generator set system may further include a load bank which is operatively coupled with the engine so as to apply an electrical load to the generator set and thereby, for example, to mitigate wet stacking with respect to the engine. The load bank can be part of a load bank system which includes other parts. Problems may arise in situating the parts of the load bank system relative to one another and other aspects of the generator set system and in increasing or decreasing the electrical load provided by the load bank.

What is needed in the art is to improve the generator set system with respect to situating the parts of the generator set and to increasing and decreasing the electrical load of the load bank.

### SUMMARY OF THE INVENTION

The present invention provides a generator set system with a load bank system with a resistor array and a load bank control panel spaced apart from the resistor array, as well as a method to increase or decrease the load provided by the load bank based upon the load relative to a predetermined maximum generator set load.

The invention in one form is directed to a generator set system which includes: a generator set including an engine and a generator operatively coupled with the engine; a radiator operatively coupled with the engine; and a load bank system including: a load bank mounted to the radiator and including a resistor array; and a load bank control panel operatively coupled with and spaced apart from the load bank.

The invention in another form is directed to a load bank system of a generator set system, the generator set system including a generator set and a radiator, the generator set including a generator set including an engine and a generator operatively coupled with the engine, the radiator being operatively coupled with the engine, the load bank system including: a load bank mounted to the radiator and including a resistor array; and a load bank control panel operatively coupled with and spaced apart from the load bank.

The invention in yet another form is directed to a method of using a generator set system, the method including the steps of: providing that the generator set system includes a generator set, a radiator, and a load bank system, the generator set including an engine and a generator operatively coupled with the engine, the radiator being operatively coupled with the engine, the load bank system including a load bank and a load bank control panel; mounting the load bank to the radiator, the load bank including a resistor array; and operatively coupling the load bank control panel with the load bank such that the load bank control panel is spaced apart from the load bank.

An advantage of the present invention is that it provides for flexibility in use of the generator set system.

Another advantage is that, by increasing and decreasing the load of the load bank relative to a predetermined maximum generator set load, the load can be increased or decreased in a safe and efficient manner.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a perspective view of a generator set system, the generator set system including a generator set and a load bank system, the generator set including an engine and a generator, in accordance with an exemplary embodiment of the present invention;

FIG. 2 is a perspective view of the generator set system of FIG. 1, in accordance with an exemplary embodiment of the present invention;

FIG. 3 is a perspective view of the generator set system of FIG. 1, in accordance with an exemplary embodiment of the present invention;

FIG. 4 is a left side view of the generator set system of FIG. 1, in accordance with an exemplary embodiment of the present invention;

FIG. 5 is a front, partial cross-sectional view of a load bank of the load bank system of FIG. 1, with portions broken away, in accordance with an exemplary embodiment of the present invention;

FIG. 6 is a flow diagram showing a method of adjusting a load applied to the generator set of FIG. 1, in accordance with an exemplary embodiment of the present invention; and

FIG. 7 is a flow diagram of a method of using the generator set system of FIG. 1, in accordance with an exemplary embodiment of the present invention.

Corresponding reference characters indicate corresponding parts throughout the several views. The exemplifications set out herein illustrate an embodiment of the invention, and such exemplifications are not to be construed as limiting the scope of the invention in any manner.

### DETAILED DESCRIPTION OF THE INVENTION

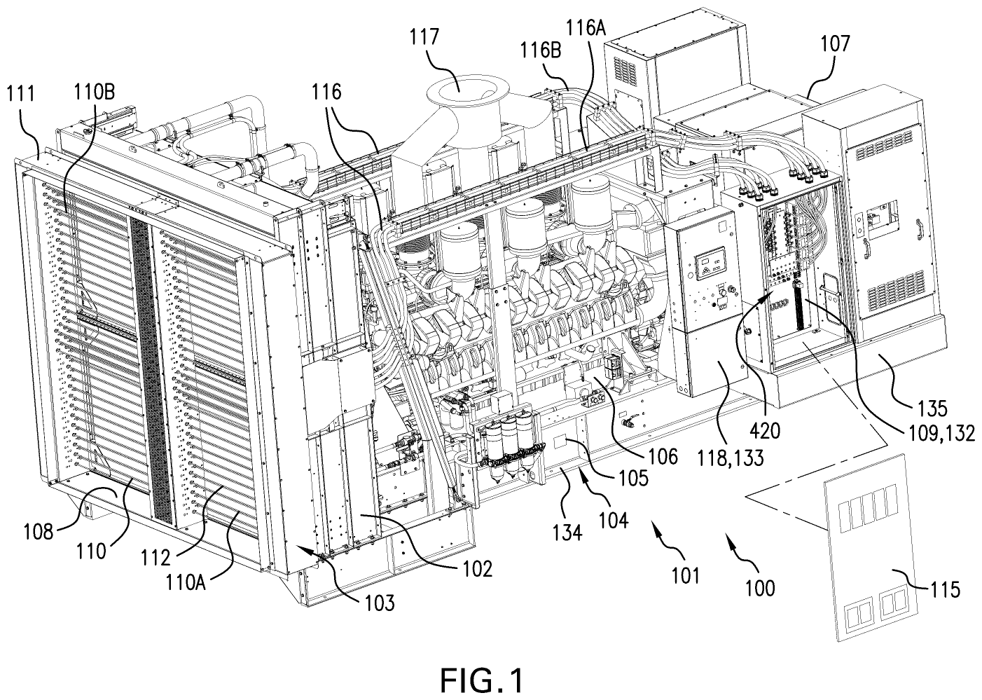

Referring now to the drawings, and more particularly to FIG. 1, there is shown a generator set system 100 (which can also be referred to herein as genset system 100), which generally includes a generator set 101 (which can also be referred to herein as genset 101), a radiator 102, a load bank system 103, and a support apparatus 104. Genset 101, which is coupled (directly or indirectly) with support apparatus 104, includes an engine 106 and a generator 107 operatively coupled with engine 106. Engine 106, which is mounted (directly or indirectly) to support apparatus 104, can be any device configured for outputting mechanical energy, including but not limited to a device powered by diesel fuel or natural gas. Engine 106 is mechanically coupled with generator 107. Engine 106 is coupled with at least one exhaust conduit 117 of genset system 100 so as to carry away exhaust gas from engine 106. Generator 107, which is coupled (directly or indirectly) with support apparatus 104, can be any device configured for converting the mechanical energy from engine 106 to electrical energy. Generator 107 is electrically coupled with one or more devices (generator loads) downstream of generator 107, and the generator loads can be any devices configured for receiving and consuming electrical energy from generator 107. Support apparatus 104 can be or include any sort of support, frame, platform, and/or the like which is configured for supporting and/or coupling with all other elements of genset system 100. Support apparatus 104 may include a support platform 134, as shown in FIG. 1, to which at least certain ones of other structures of genset system 100 may be mounted. Support apparatus 104 may further include an enclosure or housing 105 which encloses or houses (and thus goes around) at least a portion of genset 101, genset controller 118 (below) and load bank control panel 109, and/or any other structures of genset system 100. Housing 105 is shown schematically in FIG. 1 and, for illustrative purposes, is shown mounted to platform 134 (support platform 134 does not include housing 105, but, according to an embodiment of the present invention, housing 105 is attached to platform 134). Radiator 102, which includes a fan, is mounted (directly or indirectly) to support apparatus 104 and is operatively coupled with engine 106 so as to cool engine 106. For example and not by way of limitation, genset system 100 can be a part of, or otherwise coupled with, a building, such as a data center, so as to provide all or part of the electrical power needed by one, more, or all of the devices within the building, and can serve as the primary power source or secondary power source for such generator loads. According to an embodiment of the present invention, genset system 100 can be a modular device.

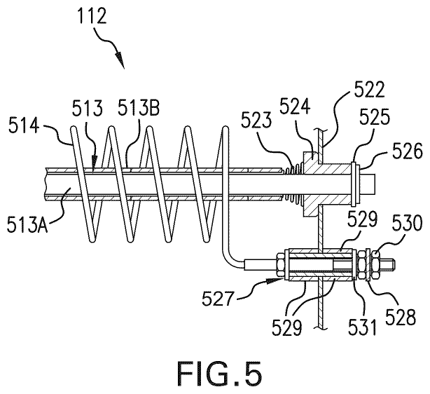

Load bank system 103 is coupled (directly or indirectly) with support apparatus 104. Load bank system 103 includes a load bank 108, a load bank control panel 109, and cables 116. Load bank 108 is mounted to a front side of radiator 102 (load bank 108 is thus a radiator-mounted load bank) and, as a resistive load bank, includes a resistor array 110. Load bank 108 is mounted to radiator 102 with a remote controller. Having load bank 108 mounted to radiator 102 facilitates use with housing/enclosure 105 and enables use of the fan of radiator 102 to cool resistance elements 514 (FIG. 5), which removes any need for other fans. In terms of left, right, front, rear herein, the left side of genset system 100 is in the foreground in FIG. 1, the right side of genset system 100 is in the background in FIG. 1, the front of genset system 100 is to the left side of the page of FIG. 1, and the rear of genset system 100 is to the right side of the page of FIG. 1. This orientation stems from the direction of air flow across at least aspects of genset system 100; that is, air flows from rear to front. More specifically, air flows from an alternator (not labeled) of genset system 100 (the alternator being at the front of genset system 100), across engine 106, through radiator 102, and then across load bank 108.

Load bank 108 serves to apply an electrical load (hereinafter, the load of load bank 108) to engine 106 (and thus more broadly to genset 101) and, as a resistive load bank, dissipates electrical energy (through resistor elements 112) as heat. Adding such a load to engine 106 by way of load bank 108 causes engine 106 to work harder (i.e., in otherwise low load conditions) such that temperatures within engine 106 (such as within combustion chambers of engine 106) and/or within the exhaust system running from engine 106 rise to levels that can at least substantially prevent wet stacking or provide other benefits. Thus, it is advantageous to run engine 106 within a range of predetermined percentages of the maximum power output of engine 106 and thus also of generator set 101, what can also be referred to as a predetermined maximum generator set load. By way of example and not limitation, it may be beneficial to ensure that genset 101 runs between 20-60% (or above) of the predetermined maximum genset load; in this way, load is added to engine 106 by way of load bank 108 so that temperatures within the combustion chamber of engine 106 and/or within the exhaust system stay at or above predetermined temperatures, for example (and not limitation), 500° F. In this way, for example, effective Exhaust Gas Aftertreatment (EGAT) can be provided for, wherein EGAT has a minimum exhaust temperature for reactions associated with EGAT to work. Thus, load bank 108 can serve to keep a minimum load on engine 106 (or, more broadly, on genset 101) to keep exhaust gas temperature at a predetermined correct temperature, so as to prevent wet stacking. In this way, load bank system 103 does not necessarily employ a temperature sensor to measure the temperature within a combustion chamber or of exhaust gas, but instead the focus is on the amount of load applied by load bank 103. Load bank 108 also serves as a way to test genset 101, without needing to use an external load bank. By way of example and not limitation, load bank system 103 can be configured to accommodate Tier 4 emissions requirements of diesel engines, including aftertreatment of exhaust gas. The exhaust system (of genset system 100) associated with engine 106 can employ selective catalytic reduction (SCR) and diesel particulate filter(s) (DPF). The present invention advantageously provides for maintaining minimum diesel engine exhaust gas temperature (EGT) amidst a variety of operating ambient conditions for proper performance of EGAT equipment.

Load bank 108 includes a frame 111 and resistor array 110 coupled with frame 111. Resistor array 110 includes resistor assemblies 112, wherein each resistor assembly 112 includes a ceramic rod 513 and a resistor element 514 (which can be referred to as a resistor or a resistor coil) coiled around ceramic rod 513, the resistor 514 being a linear coil type heating element (ceramic rod 513 and resistor element 514 are shown in FIG. 5). By way of example and not limitation, ceramic rods 513 can each be about ½ inch in diameter, and resistor elements 514 can each be about ⅛ inch to 3/16 inch in diameter. As shown in FIG. 1, each resistor assembly 112 extends horizontally. Resistor array 110 includes two sets 110A, 110B of resistor assemblies 112, wherein sets 110A, 110B are horizontally displaced relative to one another, and resistor assemblies 112 within each set 110A, 110B are arranged generally vertically relative to one another. By way of example and not limitation, each set 110A, 110B includes 36 resistor assemblies, according to an embodiment of the present invention. Load bank 108 is attached to an air input side of radiator 102 and uses the same fan and air drawn in by the fan for cooling of load bank 108, more specifically, for cooling of resistor elements 514.

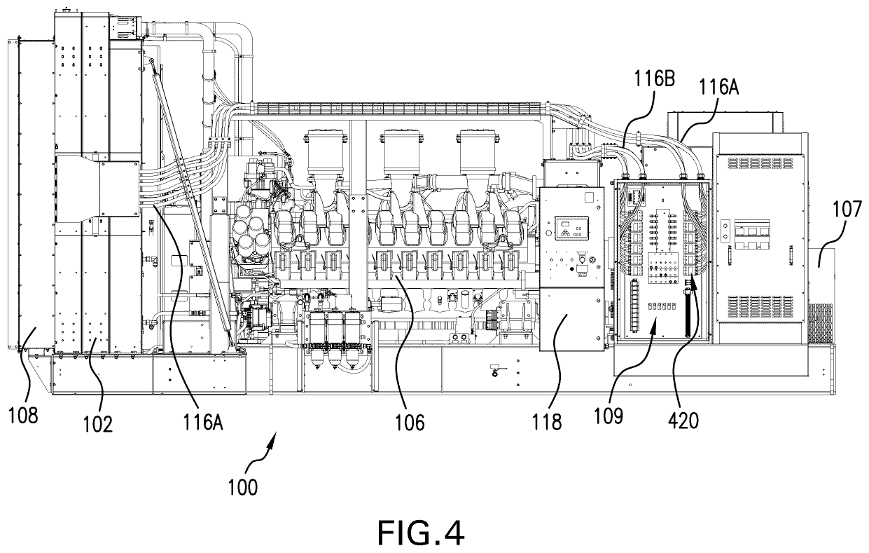

Load bank control panel 109 is mounted (directly or indirectly) to support apparatus 104, is operatively coupled with load bank 108 (more specifically, load bank control panel 109 is electrically coupled with load bank 108), is separated from and thus spaced apart from load bank 108 and thus also resistor array 110, and is, optionally, positioned within housing 105. FIG. 1 indicates that load bank control panel 109 is mounted to a platform 135 of support apparatus 104, platform 135 being mounted to platform 134 (optionally, platform 135 facilitates the lifting of weight (such as the weight of genset system 100 and the weight of structures mounted on platform 135) and properly locating the center of gravity of genset system 100 and thus also for the lifting of genset system 100). Load bank control panel 109 serves as a relay cabinet (which can also be referred to as a relay panel) with a plurality of switches 420 (FIG. 4) and thus relays for automatic and manual mode. Load bank control panel 109 includes a housing 132 and a plurality of electrical components 420 including switches 420 (FIG. 4), electrical components 420 being housed withing housing 132. Housing 132 optionally includes a front door 115 for user access inside housing 132. FIG. 1 shows front door 115 (schematically) exploded from its position covering an interior of housing 132 of load bank control panel 109 (optionally, front door 115 can be hinged on its right or left side); housing 132 thus selectively encloses electrical components 420 (according to an exemplary embodiment (and thus without limitation), door 115 can include any suitable number of horizontally oriented air vents (i.e., louvers) within the vertically oriented rectangles on the front face of door 115). Load bank control panel 109—and thus also housing 132 and electrical components 420—are spaced apart from load bank 108, and electrical components 420 are accessible by a user through housing 132 at this spaced apart location. Optionally, load bank control panel 109, as well as controller 118, genset 101 (including engine 106 and generator 107)—but not load bank 103—are housed within housing 105 and accessible through housing 105 at a location that is spaced apart from load bank 103.

Cables 116 (that is, electrical cables 116) electrically couple resistor array 110 with load bank control panel 109 and thus, more specifically, electrically couple resistor elements 514 with load bank control panel 109. Cables 116 extend from load bank 108 to load bank control panel 109. By way of example and not limitation, FIG. 1 shows a total of twelve cables 116, according to an embodiment of the present invention. Cables 116 includes a first set of cables 116A and a second set of cables 116B, each set 116A, 116B having six cables. Set 116A of cables 116 corresponds with set 110A of resistor assemblies 112, and set 116B of cables 116 corresponds with set 110B of resistor assemblies 112. Each cable 116 is electrically coupled with six ones of resistor assemblies 112, more specifically, six ones of resistor elements 514 of resistor assemblies 112. Cables 116 can connect with electrical connectors, so as to electrically couple with load bank 108. By way of example and not limitation, cables 116 are suitable for three-phase, 480 volt alternating current power.

Advantageously, the present invention incorporates load bank 108 and load bank system 103 during a diesel genset 101 manufacturing cycle while maintaining typical shipping dimensions of diesel gensets which would otherwise not include an integrated load bank (i.e., load bank 108). Further, the present invention advantageously provides for the opportunity to factory test the complete diesel genset system 101 with the integrated load bank system 103 (and thus the integrated load bank 108).

Genset system 100 further includes a generator set controller 118 which is mounted (directly or indirectly) to and thus couple (directly or indirectly)d with support apparatus 104 and is operatively coupled with other aspects of genset system 100, including engine 106, generator 107, and load bank system 103. Controller 118 monitors aspects of genset 100 and runs the control logic concerning genset system 100. For instance, controller 118 monitors aspects of load bank system 103, runs the control logic of load bank system 103, and activates and deactivates the relays of load bank control panel 109. Controller 118 includes a housing 133 that is spaced apart from load bank 108 and is accessible by a user at this spaced apart location.

Further, in general, controller 118 may correspond to any suitable processor-based device(s), such as a computing device or any combination of computing devices. Controller 118 may generally include one or more processor(s) and associated memory configured to perform a variety of computer-implemented functions (e.g., performing the methods, steps, algorithms, calculations and the like disclosed herein). Thus, controller 118 may include a respective processor therein, as well as associated memory, data, and instructions, each forming at least part of the respective controller. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory may generally include memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD), a hybrid drive, a hybrid hard drive (HHD), a hybrid solid-state drive (HHSD), a hard disk drive (HDD), a solid-state drive (SSD) (any sort of solid-state memory), and/or other suitable memory elements. Such memory may generally be configured to store information accessible to the processor(s), including data that can be retrieved, manipulated, created, and/or stored by the processor(s) and the instructions that can be executed by the processor(s). In some embodiments, data may be stored in one or more databases.

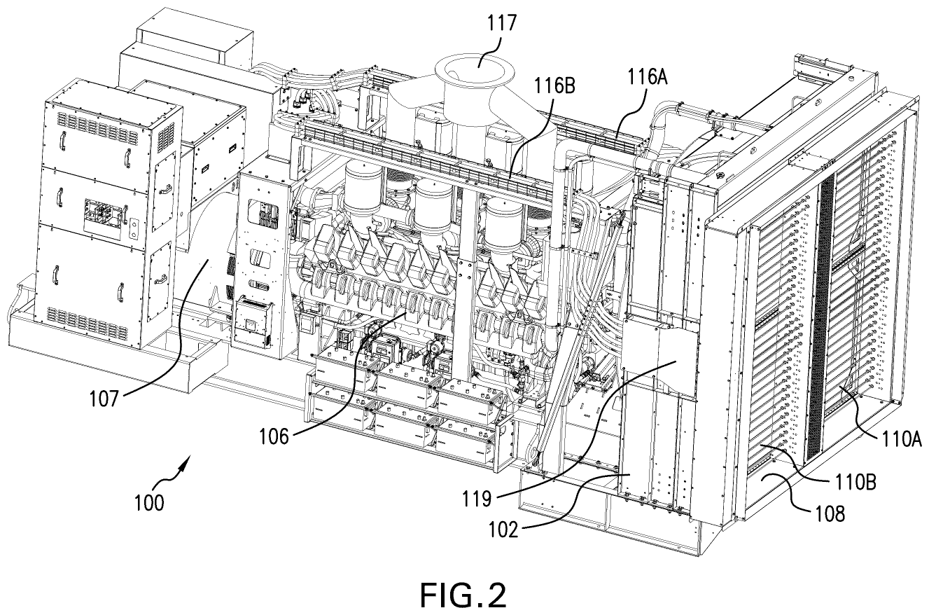

Referring now to FIG. 2, there is shown a right-front perspective view of genset system 100. Genset system 100 is shown to include radiator 102, engine 106, generator 107, load bank 108, and cabling 116A, 116B. Load bank 108 is shown to include left and right sides 110A, 110B of resistor array 110 (left and right halves of load bank 108 and thus left and right sides 110A, 110B of resistor array 110 optionally are substantially similar to one another and thus, for example (and not limitation), with respect to materials and function).

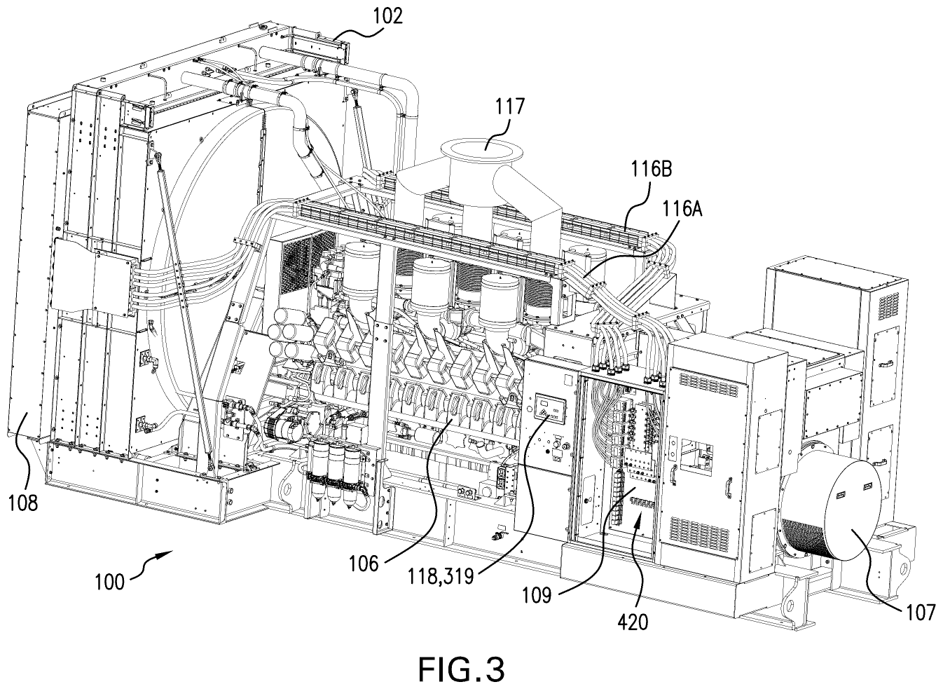

Referring now to FIG. 3, there is shown a left-rear perspective view of genset system 100. Genset system 100 is shown to include radiator 102, engine 106, generator 107, load bank 108, and cabling 116A, 116B. Controller 118 is shown to include a user interface 319. Load bank control panel 109 is shown with front door 115 removed, so as to show electrical components 420, which facilitate load bank control panel 109 as a relay and switching station.

Referring now to FIG. 4, there is shown a left side view of genset system 100. Genset system 100 is shown to include radiator 102, engine 106, generator 107, load bank 108, and cabling 116A, 116B. Load bank control panel 109 is shown with front door 115 removed, so as to show electrical components 420. For illustrative purposes, exhaust conduit 117 is omitted from FIG. 4.

Referring now to FIG. 5, there is shown a top-left, front, partial cross-sectional view of load bank 108 of load bank system 103 of FIG. 1, with portions broken away. More specifically, one resistor assembly 112 (with portions broken away) is shown in the top-left corner of load bank 108 (with portions broken away). A support wall 522 of load bank frame 111 is shown; support wall 522 supports an outer lateral end of resistor assembly 112. Resistor assembly 112 includes ceramic rod 513 (which includes an internal rod 513A and an insulator 513B therearound) and resistor element 514 coiled therearound. Resistor assembly 112 further includes support rod bushing 523, spring 524, washer 525, and pin/spring clip 526. Load bank 108 further includes an electrical connector 527 which is supported by support wall 522 and electrically coupled with an end of resistor element 514 and also with a respective cable 116. Electrical connector 527 includes a bus link 528, ceramic portions 529, and fasteners 530 (i.e., a nut, or assembled washer), and 531 (i.e., a flat washer).

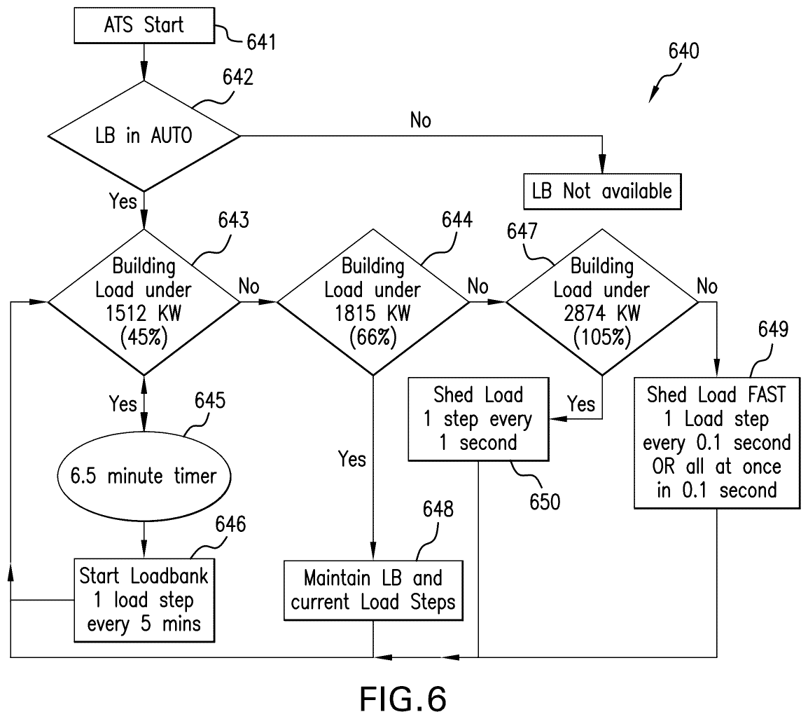

Referring now to FIG. 6, there is shown a flow diagram of a method 640 of adjusting a load applied to generator set 101. More specifically, the method 640 shown in FIG. 6 provides for adjusting a load applied to genset 101 of genset system 100 (or, more specifically, the load applied to engine 106 or generator 107) so as to provide the appropriate load to engine 106 and generator 107 within a predetermined range (i.e., 20-60% of the maximum rated load on genset 100, which is herein referred to as the predetermined maximum generator set load). The method 640 provides for: providing generator set system 100; and adjusting the load applied to genset 101 by selectively increasing or decreasing the load (by controller 118 using controller logic) based upon the load relative to the predetermined maximum generator set load (that is, a predetermined maximum engine load, or a predetermined maximum generator load), and thus not based on a temperature sensed by a temperature sensor (for example, a temperature of a combustion chamber of engine 106 or in exhaust conduit 117). The step of adjusting is performed at least in part by controller 118. The method 640 shown in FIG. 6 is one embodiment of such a method according to the present invention, but it is understood that, for instance, the number values (i.e., kW values, percentages, and times) are provided by way of example and not limitation. At block 641, an automatic transfer switch (ATS) is activated. At block 642, controller 118 checks whether load bank 108 is in auto mode or not; if not, then load bank 108 is deemed unavailable (as indicated by the block that states “LB Not available”); if so, then controller 118 begins building (increasing) load on genset 101 using load bank 108. At block 643, controller 118 checks whether the load that is being increased is below 1512 kW (which corresponds to 45% of the predetermined maximum genset load). If not, then controller 118 proceeds to block 644. If so, then at oval 645 controller 118 activates a timer for 6.5 minutes where no load (or no additional load) is provided, and then after these 6.5 minutes have elapsed load will be implemented so as to achieve or to maintain a 45% load on genset 101; that is, after these 6.5 minutes, at block 646 load bank 108 is started so as to add one load step every five minutes, wherein each load step is a predetermined amount, such as 200 kW. In this way, load is added in a step-wise manner (optionally, according to an embodiment of the present invention, load bank 108 is organized into six sets of 200 kW steps, and loads may be intended to be turned on when the load is under 20% and to be turned off when over 60% in one second intervals). Thus, one resistor 514 or one or more groups of resistors 514 are energized in steps to supply the load; according to an embodiment of the present invention, groups of six resistor elements 514 assigned to respective cables 116 forms respective groups which are energized so as to load genset 101 in steps. At block 644, controller 118 checks whether the load that is being increased is under 1815 kW (which corresponds to 66% of the predetermined maximum genset load). If not, then controller 118 proceeds to block 647. If so, then at block 648 controller 118 maintains load bank 108 and current load steps. Thus, when the load applied to generator set 101 is to be increased by the load bank system 103, the load is increased in a step-wise manner and thus using at least one load step at a first predetermined time interval based upon a predetermined percentage of the predetermined maximum generator set load. Thus, adding loads is done in steps.

At block 647, controller 118 checks whether the load that is being increased is under 2874 kW (which corresponds to 105% of the predetermined maximum genset load). If not, then controller 118 proceeds to block 649. If so, then controller 118 proceeds to block 650. At block 650, the load is shed in one step every one second (that is, in a step-wise manner). Thus, the load is decreased in a step-wise manner and thus using at least one unloading step at a second predetermined time interval based upon a predetermined percentage of the predetermined maximum generator set load. As the arrow after block 650 indicates, a loop is formed such that controller 118 returns to block 643.

At block 649, controller 118 sheds load quickly. For example, controller 118 may shed load by one load step every 0.1 seconds, which is still in a step-wise manner but is nearly continuous. Alternatively, controller 118 may shed load without any steps and thus continuously, for example, all at once; for example, the load can be dumped all at once, for example, in 0.1 seconds. Thus, the load is decreased: (a) in a step-wise manner and thus using at least one unloading step at a third predetermined time interval based upon the load being a predetermined percentage above the predetermined maximum generator set load; or (b) all at once in a predetermined amount of time based upon the load being a predetermined percentage above the predetermined maximum generator set load. With respect to alternative (a) (and by way of example and not limitation), when controller 118 detects a load over 105% (i.e., of the predetermined maximum generate set load), controller 118 will change into “shed load fast” of 0.1 second steps until the measured load is under 60% (i.e., of the predetermined maximum generate set load). As the arrow after block 649 indicates, a loop is formed such that controller 118 returns to block 643.

In use, genset system 101 can be electrically connected with a downstream load in order to supply electricity thereto. To prevent wet stacking, load bank 108 is energized to ensure that genset 101 (or, more specifically, engine 106 or generator 107) runs at a certain rated percentage of the maximum genset load (for example, 20-60%). To increase the load on genset 101, controller 118 energizes groups of resistors 514 associated with respective cables 116 in a step-wise manner, depending upon load relative to the predetermined maximum generator set load. To decrease the load on genset 101, controller 118 decreases the load on genset 101 in a step-wise manner or all at once, depending upon the load relative to the predetermined maximum generator set load.

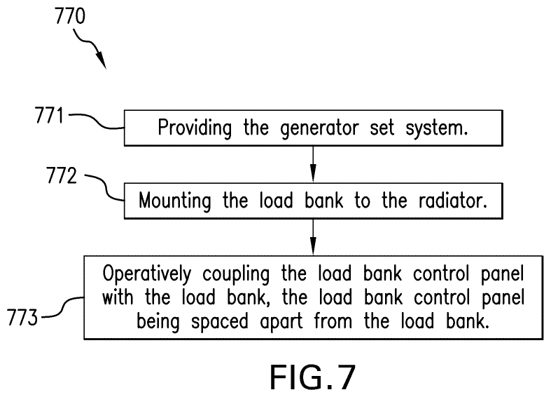

Referring now to FIG. 7, there is shown a flow diagram of a method 770 of using generator set system 100. Method 770 includes the steps of: providing 771 that generator set system 100 includes generator set 101, radiator 102, and load bank system 103, generator set 101 including engine 106 and generator 107 operatively coupled with engine 106, radiator 102 being operatively coupled with engine 106, load bank system 103 including load bank 108 and load bank control panel 109; mounting 772 load bank 108 to radiator 102, load bank 108 including a resistor array 110; operatively coupling 773 load bank control panel 109 with load bank 108 such that load bank control panel 109 is spaced apart from load bank 108. Generator set system 100 may further include a generator set controller 118 and a support apparatus 104, wherein generator set 100, radiator 102, load bank system 103, and generator set controller 118 are coupled with support apparatus 104, wherein load bank control panel 109 is operatively coupled with generator set controller 118, and wherein load bank control panel 109 includes a first housing that is spaced apart from load bank 108. Resistor array 110 may include resistor assemblies 112, wherein each resistor assemblies 112 includes a ceramic rod 513 and a resistor element 514 coiled around ceramic rod 513. Load bank system 103 may include a plurality of cables 116 electrically coupling resistor array 110 with load bank control panel 109, and wherein each one of cables 116 is electrically coupled with six ones of resistor assemblies 112. Support apparatus 104 may further include a housing 105 which encloses at least a portion of generator set 101 and load bank control panel 109. Method 770 may further include adjusting a load applied to generator set 101 by selectively increasing or decreasing the load based upon the load relative to a predetermined maximum generator set load, wherein the step of adjusting is performed at least in part by generator set controller 118, and wherein, when the load applied to generator set 101 is to be increased by load bank system 103, the load is increased in a step-wise manner and thus using at least one load step at a first predetermined time interval based upon a predetermined percentage of the predetermined maximum generator set load. Further, when the load applied to generator set 100 is to be decreased by load bank system 103, the load is decreased in a step-wise manner and thus using at least one unloading step at a second predetermined time interval based upon a predetermined percentage of the predetermined maximum generator set load. Further, when the load applied to generator set 100 is to be decreased by load bank system 103, the load is decreased: a) in a step-wise manner and thus using at least one unloading step at a third predetermined time interval based upon the load being a predetermined percentage above the predetermined maximum generator set load; or b) all at once in a predetermined amount of time based upon the load being a predetermined percentage above the predetermined maximum generator set load.

It is to be understood that the steps of method 640 (and any steps of method 770 in which method 640 forms at least a part thereof) are performed by controller 118 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by controller 118 described herein, such as the method 640, is implemented in software code or instructions which are tangibly stored on a tangible computer readable medium. The controller 118 loads the software code or instructions via a direct interface with the computer readable medium or via a wired and/or wireless network. According to one exemplary embodiment of the present invention, controller 118 is made by Basler and is typically not networked, such as for making setting changes; rather, an operator directly connected to controller 118 can make changes to the programming. Upon loading and executing such software code or instructions by controller 118, controller 118 may perform any of the functionality of controller 118 described herein, including any steps of the method 640.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A generator set system, comprising:
a generator set including an engine and a generator operatively coupled with the engine;
a radiator operatively coupled with the engine;
a load bank system including:
a load bank mounted to the radiator and including a resistor array; and
a load bank control panel operatively coupled with and spaced apart from the load bank, the load bank control panel including a housing that is spaced apart from the load bank, load bank control panel being a relay and switching station; and
a generator set controller, which includes a housing that is spaced apart from the load bank, the housing of the load bank control panel and the housing of the generator set controller being distinct relative to one another.

2. The generator set system according to claim 1, further including a support apparatus, wherein the generator set, the radiator, the load bank system, and the generator set controller are coupled with the support apparatus, wherein the load bank control panel is operatively coupled with the generator set controller.

3. The generator set system according to claim 2, wherein the resistor array includes a plurality of resistor assemblies, wherein each of the plurality of resistor assemblies includes a ceramic rod and a resistor element coiled around the ceramic rod.

4. The generator set system according to claim 3, wherein the load bank system includes a plurality of cables electrically coupling the resistor array with the load bank control panel, and wherein each of the plurality of cables is electrically coupled with six ones of the plurality of resistor assemblies.

5. The generator set system according to claim 4, wherein the support apparatus includes a housing which encloses at least a portion of the generator set and the load bank control panel.

6. The generator set system according to claim 5, wherein the generator set controller is configured for using a method including the step of:
adjusting a load applied to the generator set by selectively increasing or decreasing the load based upon the load relative to a predetermined maximum generator set load.

7. A load bank system of a generator set system, the generator set system including a generator set and a radiator, the generator set including a generator set including an engine and a generator operatively coupled with the engine, the radiator being operatively coupled with the engine, the load bank system comprising:
a load bank configured for being mounted to the radiator, the load bank including a resistor array; and
a load bank control panel operatively coupled with and spaced apart from the load bank, the load bank control panel including a housing that is spaced apart from the load bank, the housing of the load bank control panel being configured for being distinct from a housing of a generator set controller of the generator set system, load bank control panel being a relay and switching station.

8. The load bank system according to claim 7, wherein the load bank system is configured such that the generator set system further includes the generator set controller and a support apparatus, with which the generator set, the radiator, the load bank system, and the generator set controller are coupled, wherein the load bank control panel is configured for being operatively coupled with the generator set controller.

9. The load bank system according to claim 8, wherein the resistor array includes a plurality of resistor assemblies, wherein each of the plurality of resistor assemblies includes a ceramic rod and a resistor element coiled around the ceramic rod.

10. The load bank system according to claim 9, wherein the load bank system includes a plurality of cables electrically coupling the resistor array with the load bank control panel, and wherein each of the plurality of cables is electrically coupled with six ones of the plurality of resistor assemblies.

11. The load bank system according to claim 10, wherein the load bank system is configured such that the support apparatus includes a housing which encloses at least a portion of the generator set and the load bank control panel.

12. The load bank system according to claim 11, wherein the load bank system is configured such that the generator set controller is configured for using a method including the step of:
adjusting a load applied to the generator set by selectively increasing or decreasing the load based upon the load relative to a predetermined maximum generator set load.

13. A method of using a generator set system, the method comprising the steps of:
providing that the generator set system includes a generator set, a radiator, a load bank system, and a generator set controller, the generator set including an engine and a generator operatively coupled with the engine, the radiator being operatively coupled with the engine, the load bank system including a load bank and a load bank control panel;
mounting the load bank to the radiator, the load bank including a resistor array; and
operatively coupling the load bank control panel with the load bank such that the load bank control panel is spaced apart from the load bank, the load bank control panel including a housing that is spaced apart from the load bank, the generator set controller including a housing that is spaced apart from the load bank, the housing of the load bank control panel and the housing of the generator set controller being distinct relative to one another, load bank control panel being a relay and switching station.

14. The method according to claim 13, wherein the generator set system further includes a support apparatus, wherein the generator set, the radiator, the load bank system, and the generator set controller are coupled with the support apparatus, wherein the load bank control panel is operatively coupled with the generator set controller.

15. The method according to claim 14, wherein the resistor array includes a plurality of resistor assemblies, wherein each of the plurality of resistor assemblies includes a ceramic rod and a resistor element coiled around the ceramic rod.

16. The method according to claim 15, wherein the load bank system includes a plurality of cables electrically coupling the resistor array with the load bank control panel, and wherein each one of the plurality of cables is electrically coupled with six ones of the plurality of resistor assemblies.

17. The method according to claim 16, wherein the support apparatus includes a housing which encloses at least a portion of the generator set and the load bank control panel.

18. The method according to claim 17, further including adjusting a load applied to the generator set by selectively increasing or decreasing the load based upon the load relative to a predetermined maximum generator set load, wherein the step of adjusting is performed at least in part by the generator set controller, and wherein, when the load applied to the generator set is to be increased by the load bank system, the load is increased in a step-wise manner and thus using at least one load step at a first predetermined time interval based upon a predetermined percentage of the predetermined maximum generator set load.

19. The method according to claim 18, wherein, when the load applied to the generator set is to be decreased by the load bank system, the load is decreased in a step-wise manner and thus using at least one unloading step at a second predetermined time interval based upon a predetermined percentage of the predetermined maximum generator set load.

20. The method according to claim 18, wherein, when the load applied to the generator set is to be decreased by the load bank system, the load is decreased:
a) in a step-wise manner and thus using at least one unloading step at a third predetermined time interval based upon the load being a predetermined percentage above the predetermined maximum generator set load; or
b) all at once in a predetermined amount of time based upon the load being a predetermined percentage above the predetermined maximum generator set load.
